(19) United States
(12) Patent Application Publication
(10) Pub. No.: US 2004/0264171 A1
(43) Pub. Date: Dec. 30, 2004

(54) "Lightening rod"-a lighting device to light up a fluid inside of a container

(75) Inventors: Richard Eric King, Santa Paula, CA (US); April Lisa Craven, Santa Paula, CA (US)

Correspondence Address: Richard Eric King, 429 E. Virginia Terrace, Santa Paula, CA, 93060, US

(73) Assignee: Richard Eric King, Santa Paula, CA

(21) Appl. No.: 10/601,914

(22) Filed: Jun. 24, 2003

(51) Int. Cl. F21V 33/00

(52) U.S. Cl. 362/101; 362/800

(57) ABSTRACT

The lighting up of a fluid or substance within a container by use of an efficient lighting source such as an LED, small lamp, etc. for the purpose or marketing, sales, etc. The invention is to enhance the marketability of a product by making it “stand out” optically from similar products found within the same area of “point of sale”.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The “Lightening Rod”, a self contained, battery operated lighting source, is used in a receptacle such as a bottle or jar usually made of, but not limited to, plastic or glass.

### BRIEF SUMMARY OF THE INVENTION

A device to light up the fluid within a container by use of an efficient lighting source. This is used to enhance the marketability of a product by making it standout from similar products found within the same area or point of sale.

### BRIEF DESCRIPTION OF THE SEVERAL VIEWS OF THE DRAWING

Not Applicable

### DETAILED DESCRIPTION OF THE INVENTION

A device used for lighting up the fluid within a clear, translucent, or colored container by use of an efficient, self contained, lighting source such as an LED, small lamp, etc. Light source is not limited to one color, line width, or wavelength range. One could enhance the efficiency by building a flashing circuit to be used in conjunction with the lighting source to increase the life time of the desired effect. This device can be incorporated within either the physical container itself, or within the cap of the container. This optical enhancement can be made to fit in such a way as to replace the existing gasket that bottling companies already use within the area under the existing cap. If the lightening rod is used in conjunction with the cap, it can then be used at a later time as a stand alone lighting device. If the lighting rod is used in conjunction with the container it can then be used at a later time as a stand alone lighting device. This lighting device can also be used to reveal hidden optical messages that are molded within the material that make up the container. E. G. Slogans like, “get it in you” (Gatorade) could then be seen several inches away from the container at the base of the shelf, where the container is resting, or on the glass door front of the walk-in refrigerator where these items are typically kept. This light concept can be used in conjunction with optical impressions cast within the container as to illuminate a logo, text message, or convey another form of message to the consumer through this new optical advantage. This lighting device is to enhance the look of the product by making it stand out from similar products found within the same area of point of sale. “Lightening Rod” will be the trade name for this product. It will be manufactured in such a was as to minimally interfere with existing tooling, production, or manufacturing of existing products.

What I claim as my invention is:

1) A receptacle such as a bottle or jar, which comprises:
a lighting device, such as an LED, which may or may not flash, incorporated within the cap of the container or the container itself;

2) A receptacle such as a bottle or jar, which comprises:
an optical message or slogan molded within the material that makes up the receptacle revealed with the lighting device of claim 1 which projects the message.
